(19) United States
(12) Patent Application Publication
(10) Pub. No.: US 2026/0054568 A1
(43) Pub. Date: Feb. 26, 2026

(54) Method and System for Projecting Information About a Geometric Three-Dimensional User Interface Onto the User Interface

(71) Applicant: Bayerische Motoren Werke Aktiengesellschaft, Muenchen (DE)

(72) Inventor: Julian EICHHORN, Muenchen (DE)

(21) Appl. No.: 19/259,021

(22) Filed: Jul. 3, 2025

(30) Foreign Application Priority Data
Jul. 5, 2024 (DE) 10 2024 119 203.8

(51) Int. Cl. B60K 35/21; B60K 35/10

(52) U.S. Cl. CPC B60K 35/21; B60K 35/10; B60K 2360/141; B60K 2360/143; B60K 2360/146; B60K 2360/334; B60K 2360/349

(57) ABSTRACT

A method for projecting information about a geometrical three-dimensional user interface on the user interface, which is arranged, for example, in a vehicle includes the following steps: a) projecting information about a function of the user interface in the form of a physical operating element, its status, its set value, or other optically displayable information related to the operating element on at least one part of a surface of the operating element using at least one information element having a predetermined illumination intensity of the at least one information element, b) detecting a movement of a first point, facing toward the operating element, of a finger, a hand, or an elbow of a user of the operating element toward a second point on the surface of the operating element to a predetermined distance, and c) changing the projected information on the at least one part of the surface of the operating element upon reaching and/or falling below the predetermined distance between the first point and the second point such that at least one information element other than the at least one information element is displayed before reaching the predetermined distance or a further information element in addition to the at least one information element is displayed before reaching the predetermined distance, and/or a further illumination intensity of the at least one information element before reaching the predetermined distance or a/the other or further information element, which is displayed upon reaching and/or falling below the predetermined distance, is higher than the illumination intensity of the at least one displayed information element before reaching the predetermined distance.

### BACKGROUND AND SUMMARY

The disclosure relates to a method for projecting information about a geometrical three-dimensional user interface on the user interface, and a system for projecting information about a geometrical three-dimensional user interface on the user interface.

Geometrical three-dimensional user interfaces, also called 3D user interfaces, are known, e.g., physical buttons, slide controllers, rotary controllers, thumb wheels, etc. Geometrical three-dimensional user interfaces often require indicators of what state they are in (on/off, high/low, etc.). They often also require context information if an operating element has different functions in different contexts, for example, a rotary controller can select a title from a title list or can change the entertainment source in another context.

The object of the present invention is to provide a method and system which improve the user-friendliness and safety during the operation of three-dimensional user interfaces, in particular in vehicles. The invention is moreover intended to enable the user to be able to recognize the function and the status of an operating element easily, independently of the context in which the operating element is used. In vehicles, avoiding or at least reducing a distraction of the vehicle driver from the traffic by the geometrical three-dimensional user interface is to be achieved in a simple and compact manner. Moreover, blinding of the vehicle driver by the 3D user interface is to be minimized in darkness, in particular before or after the 3D user interface is operated.

This object is achieved by the subjects of the independent claims. Advantageous embodiments of the invention are specified in the dependent claims.

The invention relates to a method for projecting information about a geometrical three-dimensional user interface on the user interface which is arranged, for example, in a vehicle, in particular in a passenger vehicle, comprising the following steps:
a) projecting information about a function of the user interface in the form of a physical operating element, its status, its set value, or other optically displayable information related to the operating element on at least a part of a surface of the operating element using at least one information element having a predetermined illumination intensity of the at least one information element;
b) detecting a movement of a first point, facing toward the operating element, of a finger, a hand, or an elbow of a user of the operating element toward a second point on the surface of the operating element at a predetermined distance; and
c) changing the projected information on the at least one part of the surface of the operating element upon reaching and/or falling below the predetermined distance between the first point and the second point such that at least one information element other than the at least one information element is displayed before reaching the predetermined distance or a further information element is displayed in addition to the at least one information element before reaching the predetermined distance and/or a further illumination intensity of the at least one information element before reaching the predetermined distance or a/the other or further information element, which is displayed upon reaching and/or falling below the predetermined distance, is higher than the illumination intensity of the at least one displayed information element before reaching the predetermined distance.

The term vehicle comprises any system for conveying people and goods on roads, e.g., passenger vehicle, truck, bus, caravan, motorcycle, on rails, on the water, or in the air. The motor vehicle can be driven by any form of drive, from an internal combustion engine to a hybrid drive up to a solely electric drive.

An operation of the 3D user interface is understood hereinafter as any interaction with the user interface in which the user interface is attached. A change of a state of the 3D user interface due to the touch, for example, a change of a display of the 3D user interface without triggering a function or triggering a function does fall under an operation, but is not required for this purpose. A mechanical change of the 3D user interface triggered by the touch, for example, tilting a switch or button or rotating a rotary controller or shifting a slide controller, is also an operation in the meaning of the present invention. A movement toward the 3D user interface without touching therefore does not represent operation of the 3D user interface.

The geometry of the 3D user interface means a surface geometry, for example, a tangible bulge, a (rounded) cylinder, a groove, a lever, a web, a cuboid, thus any surface shape which an operating element can have to be tangible and operable.

A geometrical 3D user interface in the form of a passive operating element means that there are no sensors in the operating element itself and an operation is registered via a sensor outside the operating element, e.g., a camera, lidar, or the like. The surface of the operating element is insofar completely passive. This can be, for example, a simple door panel or instrument panel surface, or a seat cover. A geometrical 3D user interface in the form of a wired operating element means that a sensor is installed in the operating element, which detects the operation on location, thus at the location of the operating element, e.g., an electric button, rotary actuator increment generator, capacitive touch pad, electric switch, pressure sensor, or the like. This sensor can be installed in the or at the surface of the operating element. A detection of a function change of the operating element by this sensor is also possible.

The predetermined illumination intensity of the at least one information element in step a) before a movement toward the predetermined distance according to step b), thus at a distance greater than the predetermined distance, can be zero. The predetermined distance in step b) can be, for example, 30 cm, 20 cm, 10 cm, 5 cm, 4 cm, 3 cm, 2 cm, 1 cm, or a distance value in between. The predetermined distance can be determined in that, above a surface of the operating element at the predetermined distance in the normal direction on the surface, a further surface is defined which is spaced apart from the surface of the operating element by the predetermined distance.

In that in step c) the at least one information element other than the at least one information element is displayed before reaching the predetermined distance or the further information element is displayed in addition to the at least one information element before reaching the predetermined distance and/or the further illumination intensity of the at least one information element before reaching the predetermined distance or a/the other or further information element, which is displayed upon reaching and/or falling below the predetermined distance, is higher than the illumination intensity of the at least one displayed information element before reaching the predetermined distance, the geometrical 3D user interface in the form of the physical operating element is already enhanced upon reaching and/or falling below the predetermined distance for operation, for example, by a visually calmed mode having minimal or even no inscription, to an interaction mode without touching, for example, scales enriched with further information, numbers, lists, icons, and/or further possible interactions. Before reaching the predetermined distance, thus in a calmed mode, the distraction and blinding is less in particular when driving at night and the surroundings around the operating element, for example, a vehicle interior, appears optically more roomy and appealing, but it remains able to be found with little projection content.

In the interaction mode, thus upon reaching and/or falling below the predetermined distance, the user sees at least the information necessary for interaction/operation. After removing the hand from the operating element and exceeding the predetermined distance, for example, in the form of specific coordinates in xyz adjacent to and/or above the operating element, a timer can start, for example, with a timeout of, for example, 3000 ms. After expiration of the timer and if a renewed movement toward does not take place, the user interface can change back into the calmed mode. The change of the projected information on the at least one part of the surface of the operating element upon reaching and/or falling below the predetermined distance can comprise a display or deletion of a projected indicator on or adjacent to the operating element or a change of a projected scale or a projected icon.

In embodiments of the invention, as already stated above, the detection of the movement of the first point toward the second point according to step b) takes place in Cartesian coordinates x, y, z and the predetermined distance is reached and/or fallen below if further predetermined distances in the x, y, and z direction are reached and/or fallen below. In this way, the movement toward can be detected easily and reliably. One or more detection sensors can be arranged at or in the operating element, adjacent to the operating element, or above the operating element.

Advantageously, reaching and/or falling below the predetermined distance, the change of the projected information on the at least one part of the surface of the operating element according to step c) on the other or the further information element, and/or the further illumination intensity of the at least one information element before reaching the predetermined distance or the other or the further information element takes place continuously with a decreasing distance of the first point from the second point. Continuously can mean that the other or the further information element and/or the further illumination intensity of the at least one information element increases linearly or nonlinearly with time. In this way, the change can take place fluidly, so that a user is not surprised by the change. Moreover, a distance hysteresis can ensure damping upon the fading in and out and avoid flickering. This serves for safety in the vehicle environment. In addition, a continuous transition of the change of the projected information, thus from the calmed mode into the interaction mode before touch or in the operating mode with touch of the operating element is perceived as more pleasant by a user than an abrupt change.

In embodiments of the invention, the at least one part of the surface of the operating element comprises a part of a surface of an actuator of the operating element and a further part of a surface area around the actuator of the operating element and the projection of information according to step a) takes place on the part of the surface of the actuator of the operating element and/or the further part of the surface area around the actuator of the operating element. In this way, the projected information can be displayed more comprehensively on the operating element than would be the case if only the actuator, for example, a knurled wheel or a switch/button, were used as the projection surface.

The projection of information on the at least one part of the surface of the operating element according to step a) advantageously takes place from a projection position remote from the operating element, in particular from a projection position on a ceiling of an interior of the vehicle if the operating element is arranged in the vehicle. In this way, a simple and compact projection can be implemented, using which more than only one operating element can optionally be provided with projected information.

If the detection of the movement of the first point toward the second point according to step b) takes place from a detection position remote from the operating element, in particular from a detection position at a/the ceiling of a/the interior of the vehicle if the operating element is arranged in the vehicle, a simple and compact approach detection can be implemented, using which more than only one operating element can optionally be detected by the movement toward.

In embodiments of the invention, it is provided that devices used for the projection of information according to step a) and the detection of the movement of the first point toward the second point according to step b) are used not only for the operating element, but for multiple physical operating elements or at least the one physical operating element and at least one geometrical two-dimensional user interface, for example, a touch operating element or slider. This saves installation space and costs for further projection and/or approach detection devices. In the vehicle environment, this moreover results in a roomy interior which is visually appealing for the user.

The following further steps are advantageously provided:
d) maintaining the change of the projected information on the at least one part of the surface of the operating element according to step c) on the other or the further information element and/or the further illumination intensity of the at least one information element before reaching the predetermined distance or the other or the further information element as long as the operating element is operated; and/or
e) detecting a movement of a third point, facing toward the operating element, of the finger, the hand, or the elbow of the user of the operating element away from a fourth point on the surface of the operating element from a distance less than or equal to a further predetermined distance, which is, for example, greater than or equal to the predetermined distance, beyond the further predetermined distance; and
f) changing the projected information on the at least one part of the surface of the operating element back to the at least one information element having the predetermined illumination intensity if the further predetermined distance is exceeded between the third point and the fourth point.

In this way, the user-friendliness and safety in the operation of three-dimensional user interfaces, in particular in vehicles, is improved not only upon movement toward the operating element, but rather also upon moving away from the operating element. Without operation, a vehicle driver is distracted less from the traffic by the operating element than would be provided without the present invention, thus if only one operating mode were provided-without calmed mode.

Advantageously, the change of the projected information on the at least one part of the surface of the operating element upon exceeding the further predetermined distance between the third point and the fourth point according to step f) first takes place when, after the detection of the movement of the third point away from the fourth point, a time interval, for example, a value between 3000 ms and 5000 ms, has expired or a hysteresis loop between the predetermined distance upon movement toward according to step b) and the further predetermined distance upon exceeding according to step f) has passed. In this way, in the case of a change between exceeding and falling below the predetermined distance, shaking of the projected information on the operating element is avoided. This serves for the safety in the vehicle environment, since the user is not distracted as much as would be the case without time interval or hysteresis loop.

The operating element advantageously comprises an operating element sensor for detecting an operation of the operating element, for example, an electrical or inductive switch/button, capacitive sensors such as a capacitive touchpad, pressure sensor or rotary actuator increment generator, which is used in particular in step d) to detect an operation of the operating element. In the case of arrangement above the operating element, one projection device and/or one approach detection device can be used for several of the operating elements, in particular those listed as examples.

In embodiments, steps a) to c) and steps e) and f) are repeated, in particular continuously, until the operating element is switched off. Continuously can mean that the other or the further information element and/or the further illumination intensity of the at least one information element increases linearly or non-linearly with time. In this way, the change can take place fluidly, so that a user is not surprised by the change. This serves for the safety in the vehicle environment. In addition, a continuous transition of the change of the projected information, thus from the calmed mode into the interaction mode before touch or into the operating mode with touch of the operating element, is perceived as more pleasant by a user than an abrupt change.

The invention also comprises a system for projecting information about a geometrical three-dimensional user interface on the user interface, which is arranged, for example, in a vehicle, in particular a passenger vehicle, in particular for carrying out the above-described method and its embodiments, comprising:
a projection device, in particular in the form of a video projector, which is configured to project information about a function of the user interface in the form of a physical operating element, its status, its set value, or other optically displayable information related to the operating element on at least one part of a surface of the operating element having at least one information element having a predetermined illumination intensity of the at least one information element;
a detection device, in particular in the form of an infrared camera, depth camera, a lidar sensor, or an ultrasonic sensor, which is configured to detect a movement of a first point, facing toward the operating element, of a finger, a hand, or an elbow of a user of the operating element toward a second point on the surface of the operating element to a predetermined distance; and
c) a control device, which is configured to change the projected information on the at least one part of the surface of the operating element upon reaching and/or falling below the predetermined distance between the first point and the second point such that at least one information element other than the at least one information element is displayed before reaching the predetermined distance or a further information element to the at least one information element is displayed before reaching the predetermined distance and/or a further illumination intensity of the at least one information element before reaching the predetermined distance or a/the other or further information element, which is displayed upon reaching and/or falling below the predetermined distance, is higher than the illumination intensity of the at least one displayed information element before reaching the predetermined distance.

The control device can be part of a server, provided distributed on multiple servers, and in particular can comprise a part of a computing unit, in particular of a vehicle. Data for the control of the change of the projected information can be provided in the vehicle environment, for example, by an ECU (electronic control unit) of a vehicle of the user and/or a server of the infrastructure of the ECU. The steps to be carried out by the control unit can be performed there.

The system for projecting information about a geometrical three-dimensional user interface on the user interface is suitable for carrying out the above-described method and has the same advantages and effects as are mentioned in conjunction with the above-described method.

The invention also comprises a computer program product, comprising commands, which, when the method is carried out by a computer, cause the computer to carry out the method.

The invention additionally comprises a computer-readable medium on which the computer program product is stored.

Exemplary embodiments of the invention are shown in the figures and will be described in more detail hereinafter. If not indicated otherwise, identical reference signs are used hereinafter for identical and identically-acting elements.

### BRIEF DESCRIPTION OF THE DRAWINGS

FIGS. 1A-1G show a schematic representation of steps of the method for projecting information about a geometrical three-dimensional user interface on the user interface in a first embodiment using the system according to the invention in a first embodiment;

FIG. 2 shows a schematic representation of the system for projecting information about a geometrical three-dimensional user interface on the user interface in a second embodiment;

FIGS. 3A, 3B show a diagram to represent the steps of the method according to the invention in second (FIG. 3A) and third embodiments (FIG. 4B); and

FIGS. 4A-4C show a schematic representation of steps of the method for projecting information about a geometrical three-dimensional user interface on the user interface in a fourth embodiment using a system according to the invention in a third embodiment.

### DETAILED DESCRIPTION OF THE DRAWINGS

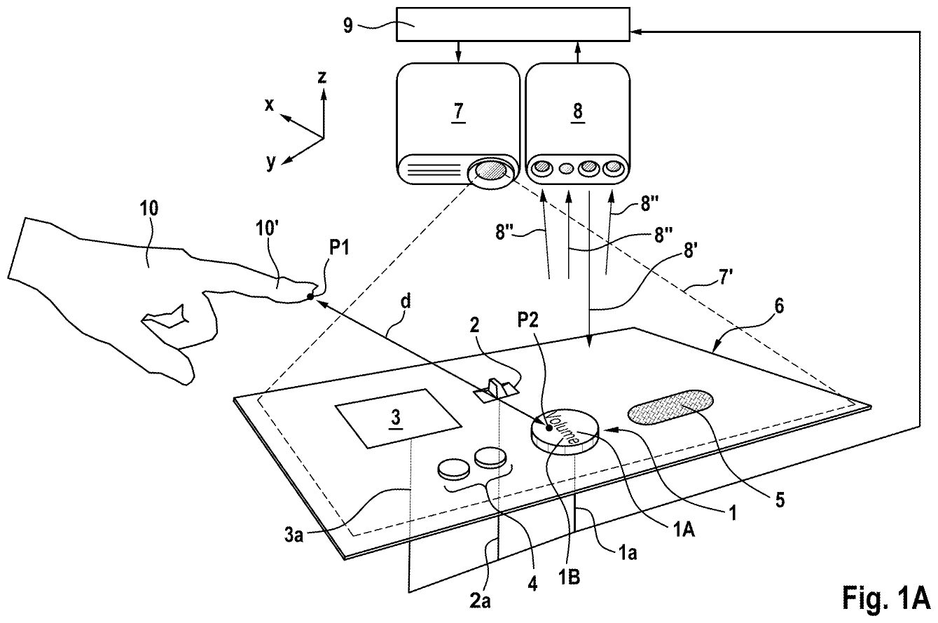

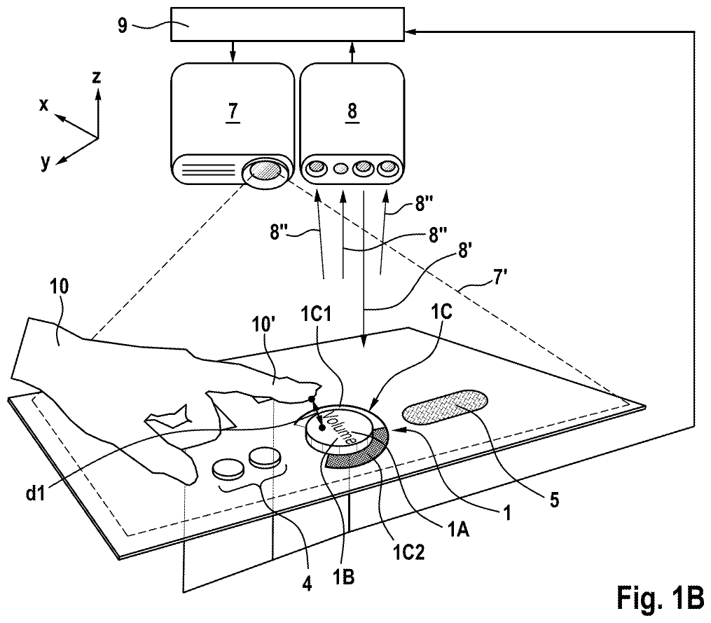

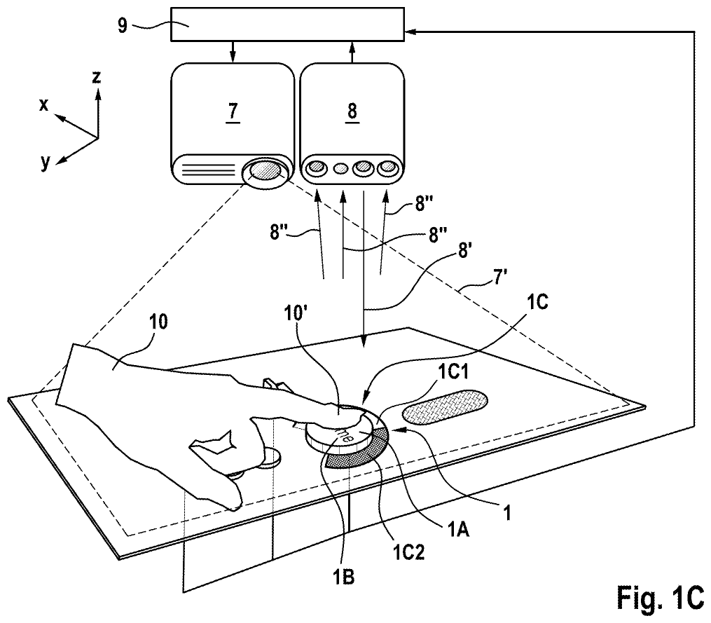

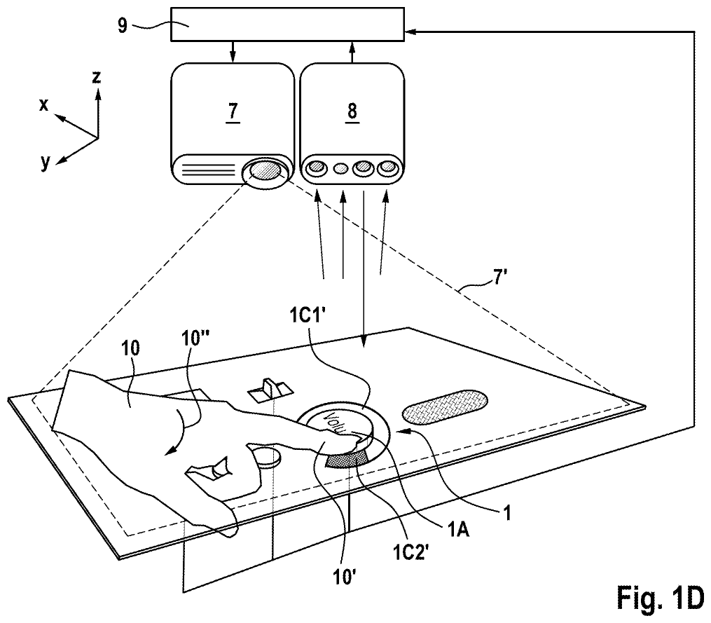

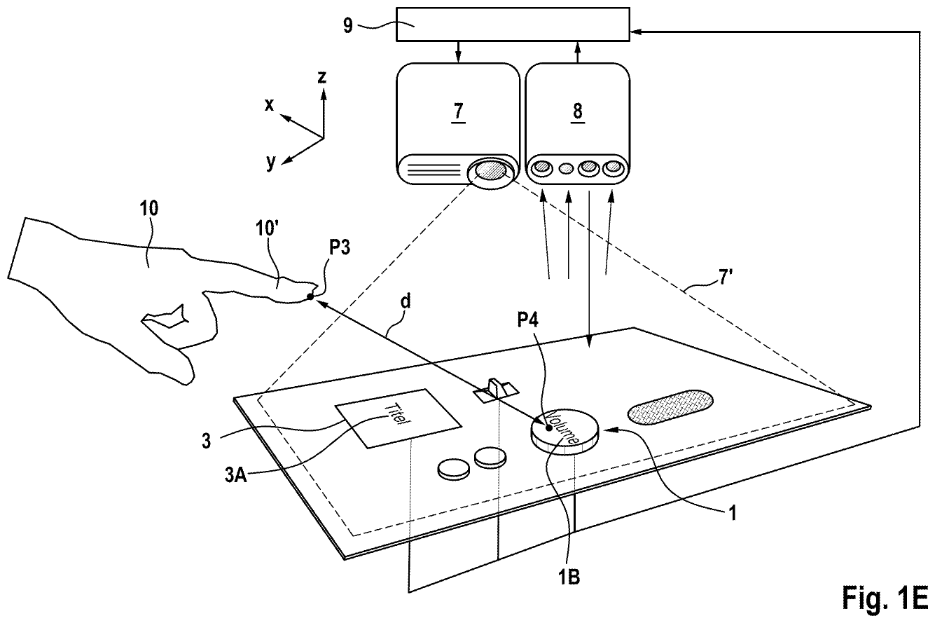

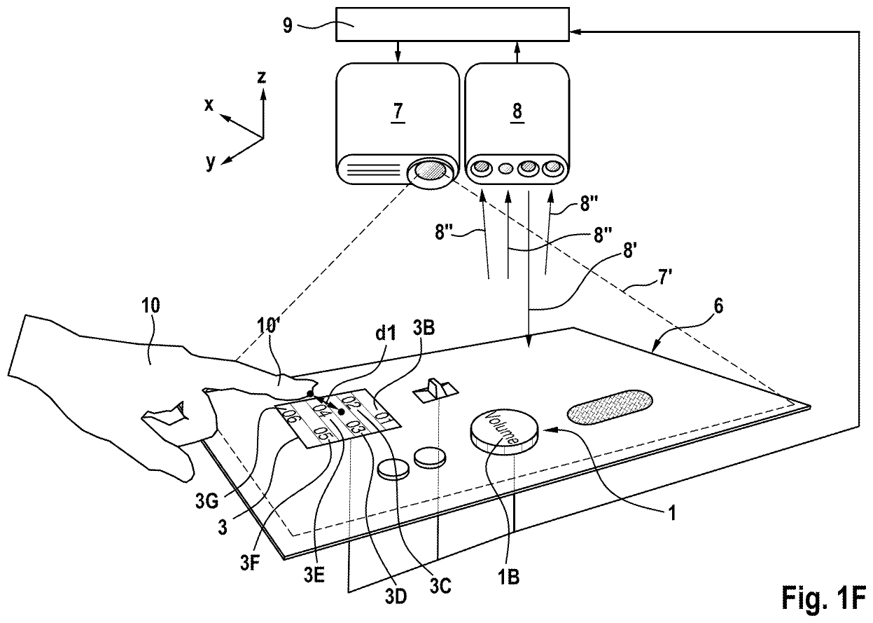

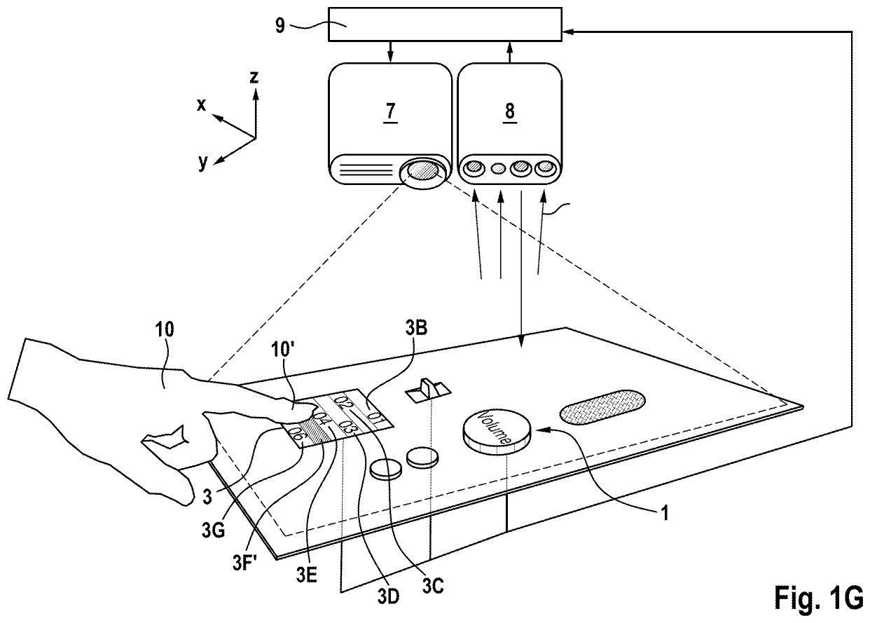

FIG. 1A shows the system according to the invention for projecting information about a geometrical three-dimensional user interface on the user interface in a first embodiment. A first user interface is a physical operating element 1 in the form of a rotary controller, which comprises a rotatable actuator 1A. The rotary controller is provided as a wired operating element, wherein a sensor is installed that detects the operation at the location of the operating element 1, e.g., an electric switch, rotary actuator increment generator, capacitive touch pad, electric switch, pressure sensor, or the like. This sensor can be installed in the or at the surface of the actuator 1A of the operating element 1. On the panel 6, an electric switch is arranged as a further physical operating element 2, a touchpad is arranged as an operating element 3, two electrical switches operable independently of one another are arranged as an operating element 4, and a slider is arranged as an operating element 5. The operating elements 1 to 3 are wired and emit an operating status via lines 1a, 2a and 3a about the operation at the location of the respective operating element 1 to 3 to a control device 9. The operating elements 4 and 5 are passive operating elements, wherein the operating status thereof is detected via the operation at the location of the respective operating element 4, 5 by a detection device 8 in the form of an infrared camera. Instead of an infrared camera, a depth camera, a lidar sensor, or an ultrasonic sensor or a combination of multiple identical or different detection devices 8 is also possible. The detection device 8 can emit an emission signal 8′for this purpose, which is reflected from a hand 10 or a finger 10′as a reflection signal 8″. An evaluation of the reflection signal 8″ permits a detection of a movement of a first point P1, facing toward the operating element 1, 2, 3, 4, 5, of the finger 10′, the hand 10, or an elbow of a user of the operating element 1, 2, 3, 4, 5 toward a second point P2 on the surface of the operating element 1, 2, 3, 4, 5 to a predetermined distance d1, for example, 30 cm, 20 cm, 10 cm, 5 cm, 4 cm, 3 cm, 2 cm, 1 cm, or a distance value therebetween. For the passive operating elements 4 and 5, the detection device 8 can also detect smaller distances d than the predetermined distance d1 (not shown) between the first and second points P1 and P2, in particular an absolute position of the point P1 in space, in order to determine therefrom whether one or both of the operating elements 4, 5 was operated. A touch of the operating element is already considered an operation. A change of a status due to the touch, for example, a triggering of a function is considered part of the operation, but is not required for this purpose. The detection device 8 can detect an operation of the wired operating elements 1 to 3 and/or the passive operating elements 4, 5. For this purpose, the detection device 8 is arranged above the operating elements 1, 2, 3, 4, 5, which are located in an x/y plane, in the z direction.

A projection device 7, in particular in the form of a video projector, for projecting information 1B about a function of at least the physical operating element 1, its status, its set value, or other optically displayable information related to the operating element on at least a part of the surface of at least the operating element 1 having at least the information element 1B using a predetermined illumination intensity of at least the information element 1B is also arranged above the x/y plane having the physical operating elements 1, 2, 3, 4, 5 in the z direction. “Volume” is displayed by the information element 1B, for example, of an entertainment system, which is in particular installed in a vehicle. In FIG. 1A, the information element 1B is projected on the surface of the actuator 1A of the operating element 1 by the projection device 7, wherein it is established by the detection device 8 that the distance d between the first point P1 and the second point P2 is greater than the predetermined distance d1. The projection device 7 radiates a projection area 7′, using which a substantial area of the panel 6 can be illuminated, in particular surfaces of the operating elements 1, 2, 3, 4, 5.

It can be seen in FIG. 1B that the first point P1 of the finger 10′of the hand 10 of the user of the operating element 1 has moved toward the second point on the surface of the operating element 1 coming from the distance d to the distance d1. The control device 9, to which, in addition to the wired operating elements 1 to 3, the projection device 7 and the detection device 8 are connected, ensures that the projected information on the at least one part of the surface of the operating element 1 is changed upon reaching and/or falling below the predetermined distance d1 between the first point P1 and the second point P2 such that a further information element 1C1, 1C2 is displayed in addition to the at least one information element 1B before reaching the predetermined distance d1. The surface of the operating element 1 comprises, in addition to the surface of the actuator 1A of the operating element 1, a further part 1C of a surface area around the actuator 1A and the projection of the further information elements 1C1, 1C2 takes place on the further part 1C of the surface area around the actuator 1A. Information elements 1C1, 1C2 form an open ring around the actuator 1A, on which a volume is indicated such that it is higher the larger the angle segment of the open ring is that is occupied by the information element 1C1. If the information element 1C1 in the form of a ring segment 1C1 shown brighter than the information element 1C2 is sufficiently large that the ring segment 1C1 shown darker than the information element 1C1 is small or is no longer present, a maximum volume is reached.

FIG. 1C shows that the change of the projected information from the information element 1B to the information element 1B expanded by the further information elements 1C1, 1C2 is maintained as long as the operating element 1 is operated. The operation of the operating element 1 does not consist of a change of the volume, but rather a touch of the surface of the actuator 1A.

FIG. 1D shows that the operation of the operating element 1 consists of a change of the volume. The volume is increased in relation to the volume shown in FIG. 1C, since the further information element 1C1′ is increased in angle segment clockwise in relation to the further information element 1C1 and the further information element 1C2′ is decreased in angle segment counterclockwise in relation to the further information element 1C2. The further information elements 1C1′, 1C2′ are shown differently in comparison to the further information elements 1C1, 1C2 due to the increased volume. The change of the projected information on the surface of the operating element 1 by expansion from the information element 1B to this element and the further information elements 1C1′, 1C2′ is maintained as long as the operating element 1 is operated.

FIG. 1E shows that a movement of a third point P3, facing toward the operating element 1, of the finger 10′of the hand 10 of the user of the operating element 1 away from a fourth point on the surface of the operating element 1 has increased from a distance less than or equal to a further predetermined distance d2 (not shown), which is, for example, greater than or equal to the predetermined distance d1, beyond the further predetermined distance d2 and the increase in movement away beyond the distance d2 was detected by the detection device 8. A change of the projected information on the surface of the operating element 1 thereupon takes place upon exceeding the further predetermined distance d2 between the third point P3 and the fourth point P4 back to the information element 1B without the further information elements 1C1, 1C2 or 1C1′, 1C2′. The operating element 3 displays the information element 3A in the form of “title” before reaching the predetermined distance d1 (not shown).

FIG. 1F shows that the finger 10′of the hand 10 has reached the predetermined distance d1, due to which a change of the projected information from 3A having the word “title” to a displayed list having the numbers “01”, “02”, “03”, “04”, “05”, and “06” takes place. These numbers are provided as further information elements 3A, 3B, 3C, 3D, 3E, 3F and 3G. Upon operation of the operating element 3 in the form of the touchpad as shown in FIG. 1G by tapping the element 3F, detected by the wired touchpad itself and/or the detection device 8, this element 3F is displayed in modified form as element 3F′, for example, as shown in darkened form, for optical feedback of the selection of the title “05”, by the projection device 7.

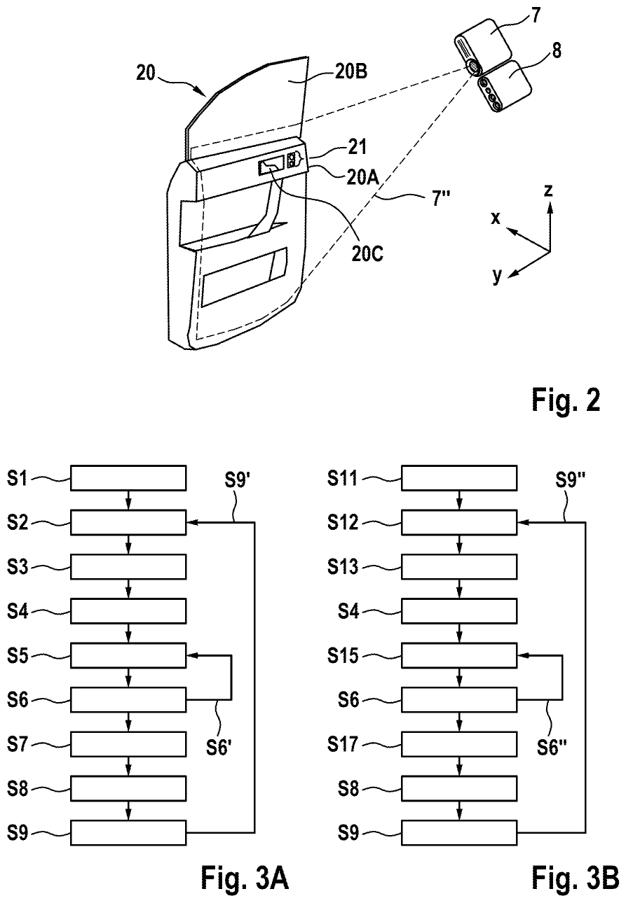

FIG. 2 schematically shows the system for projecting information about a geometrical three-dimensional user interface on the user interface in a second embodiment. A vehicle door 20 has a door inner panel 20A, a door window 20B, and a door lock actuating element 20C. An operating element 21 in the form of two buttons to raise and lower the door window 20B is arranged adjacent to the actuating element 20C. The door inner panel 20A, which is aligned essentially in the y/z plane, is illuminated by the projection device 7 above the door inner panel 20A, which is arranged at least partially in the negative x direction in relation to the door inner panel 20A. In addition to the projection device 7, the detection device 8 is arranged, for example, at or in a vehicle ceiling, so that a projection area 7″ of the projection device 7 is not restricted by the detection device 8 and a detection area of the detection device 8 is not restricted/impaired by the projection device 7. Therefore, information elements can be projected over the entire door inner panel 7″ by the projection device 7 and distances to the operating element 21 can be detected by the detection device 8. In this way, scarce installation space in the door for detection and/or projection is saved and a simple and cost-effectively implementable system is provided using only one projection device and detection device (control device not shown).

FIG. 3A shows a diagram to illustrate the steps of the method according to the invention in a second embodiment for at least one passive operating element. In step S1, information about a function of the passive physical operating element 4, 5, its status, its set value, or other optically displayable information related to the operating element is projected on at least a part of a surface of the operating element 4, 5 using at least one information element 1B having a predetermined illumination intensity of the at least one information element 1B. In step S2, a distance between the first and second points P1, P2 of a finger 10′, a hand 10, or an elbow of a user at a distance from the operating element is detected. In step S3, a movement of the first point P1, facing toward the operating element 4, 5, toward the second point P2 on the surface of the operating element 4, 5 to the predetermined distance d1 is detected. In step S4, the projected information on the at least one part of the surface of the operating element 4, 5 is changed upon reaching and/or falling below the predetermined distance d1 such that at least one information element 1B′ other than the at least one information element 1B is displayed before reaching the predetermined distance or a further information element 1C1, 1C2 in addition to the at least one information element 1B is displayed before reaching the predetermined distance d1, and/or a further illumination intensity of the at least one information element 1B before reaching the predetermined distance d1 or a/the other information element 1B′ or further information element 1C1, 1C2, which is displayed upon reaching and/or falling below the predetermined distance d1, is higher than the illumination intensity of the at least one displayed information element 1B before reaching the predetermined distance d1. In step S5, an operation of the operating element 4, 5 can be detected/established by the detection device 8. In step S6, a change of the projected information on the at least one part of the surface of the operating element 4, 5 to the other information element 1B′ or the further information element 1C1, 1C2 and/or the further illumination intensity of the at least one information element 1B before reaching the predetermined distance d1 or the other information element 1B′ or the further information element 1C1, 1C2 can be maintained as long as the operating element 4, 5 is operated. In step S7, a detection of a movement of a third point P3, facing toward the operating element 4, 5, of the finger 10′, the hand 10, or the elbow of the user of the operating element away from a fourth point P4 on the surface of the operating element from a distance less than or equal to a further predetermined distance d2, which is, for example, greater than or equal to the predetermined distance d1, beyond the further predetermined distance d2 can take place. In step 8, after the detection of the movement of the third point P3 away from the fourth point P4, a time interval passes, for example, a value between 3000 ms and 5000 ms, before, in step 9, the projected information on the at least one part of the surface of the operating element 4, 5, upon exceeding the further predetermined distance d2 between the third point P3 and the fourth point P4, is changed back to the at least one information element 1B having the predetermined illumination intensity. Steps 5 and 6 for detecting an operation of the operating element 4, 5 and maintaining the change according to step 4 can be immediately repeated, as shown in step 6′. Steps 2 to 9 and 6′can be continuously repeated, see step S9′, until the operating element 4, 5 is switched off.

FIG. 3B shows a further diagram to illustrate the steps of the method according to the invention in a third embodiment for at least one wired operating element. In step 11, information about a function of the wired physical operating element 1, 2, 3, its status, its set value, or other optically displayable information related to the operating element is projected on at least a part of a surface of the operating element 1, 2, 3 using at least one information element 1B having a predetermined illumination intensity of the at least one information element 1B. In step S12, a distance between the first and second points P1, P2 of a finger 10′, a hand 10, or an elbow of a user at a distance from the wired operating element is detected by means of the operating element itself. In step S13, a movement of the first point P1, facing toward the wired operating element 1, 2, 3, toward the second point P2 on the surface of the operating element 1, 2, 3 to the predetermined distance d1 is detected by means of a wired proximity sensor at or in the operating element 1, 2, 3. Steps 4, 6, 8 and 9 in FIG. 3B correspond to steps 4, 6, 8 and 9 in FIG. 3A. In step S15, an operation of the operating element 4, 5 can be detected/established by the operating element 1, 2, 3 itself. In step S17, a movement of a third point P3, facing toward the operating element 4, 5, of the finger 10′, the hand 10, or the elbow of the user of the operating element away from a fourth point P4 on the surface of the operating element from a distance less than or equal to a further predetermined distance d2, which is, for example, greater than or equal to the predetermined distance d1, beyond the further predetermined distance d2 can be detected by the wired proximity sensor at or in the operating element 1, 2, 3. Steps S6″ and S9″ in FIG. 3B correspond to steps S6′ and S9′ in FIG. 3A.

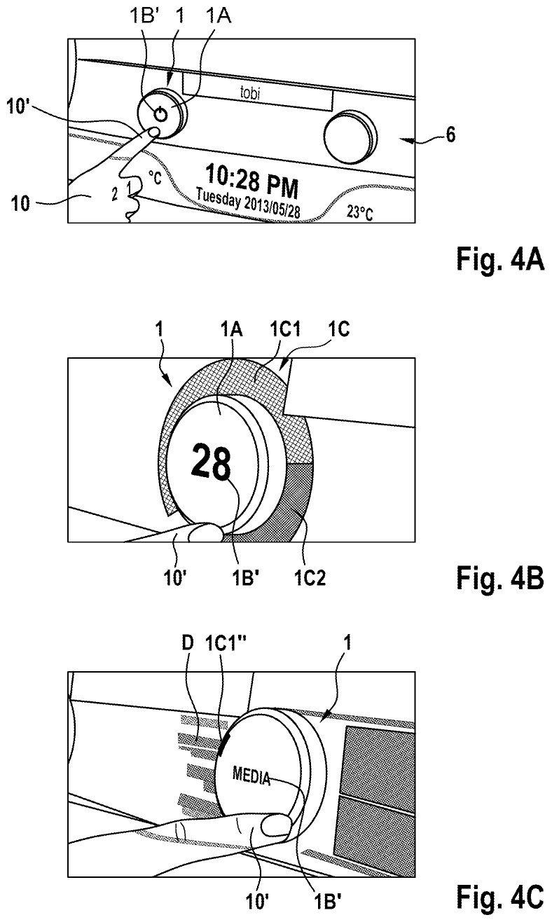

FIGS. 4A to 4C schematically show steps of the method for projecting information about the operating element 1 on the operating element 1 in a fourth embodiment using a system according to the invention in a third embodiment in a vehicle environment in the interior of a vehicle. In FIG. 4A, the user of the operating element 1 falls below the predetermined distance d1 with the finger 10′of his hand 10, so that instead of no projection before falling below the predetermined distance d1, the further information element 1B′ is projected in the form of a standby symbol on the operating element 1. The panel 6 only has two operating elements 1 having rotary actuators as actuators 1A, which leaves a roomy and clear impression of the arrangement of the operating elements in the interior of the vehicle.

In FIG. 4b, the user operates the operating element 1, by which the further operating element 1B′ is changed from the standby symbol to a numeric indication of the current volume. In addition, in the area 1C around the actuator, information elements 1C1 and 1C2 are displayed around the actuator 1A, wherein the angle segment of the information element 1C1 indicates the selected volume as part of the maximum volume, which is shown in total by the angle segments of both information elements 1C1 and 1C2. Instead of the volume of an entertainment system in the vehicle, a temperature in the vehicle interior can also be projected on the operating element 1.

In FIG. 4C, an information element 1B′ “media” is projected as a symbol for the source selection for the entertainment system of the vehicle on the actuator 1A of the operating element 1 on the same operating element 1 instead of the volume/temperature upon falling below the predetermined distance d1 and upon operation. The further information element 1C1″ shows a curved bar, which symbolizes a chosen selection depending on the position at the edge of the actuator 1A. In addition to the information elements 1B′ and 1C1″ projected on the operating element 1, the same or multiple projection devices project a further information element on the panel 6 such that the impression of a display D arranged adjacent to the operating element 1 results. The information content displayed on the display D is correlated with the information elements displayed on the operating element 1. In addition to the information elements 1B′ and 1C1″ projected on the operating element 1, further information elements can also be projected in the surroundings of the operating element on the panel 6 by the same or multiple projection devices.

The features of the invention described with reference to the illustrated embodiments can also be present in other embodiments of the invention, unless indicated otherwise or itself forbidden for technical reasons.

1.-14. (canceled)

15. A method for projecting information, about a geometrical three-dimensional user interface, on the user interface, which user interface is arrangeable in a vehicle, the method comprising the steps of:
a) projecting information about a function of the user interface which is in a form of a physical operating element, its status, its set value, or other optically displayable information related to the operating element, on at least one part of a surface of the operating element using at least one information element having a predetermined illumination intensity of the at least one information element;
b) detecting a movement of a first point (P1), facing toward the operating element, of a finger, a hand, or an elbow of a user of the operating element toward a second point (P2) on the surface of the operating element to a predetermined distance (d1), and
c) changing the projected information on the at least one part of the surface of the operating element upon reaching and/or falling below the predetermined distance between the first point and the second point such that at least one information element other than the at least one information element is displayed before reaching the predetermined distance or a further information element in addition to the at least one information element is displayed before reaching the predetermined distance, and/or a further illumination intensity of the at least one information element before reaching the predetermined distance or a/the other or further information element, which is displayed upon reaching and/or falling below the predetermined distance, is higher than the illumination intensity of the at least one displayed information element before reaching the predetermined distance.

16. The method according to claim 15, wherein
the detection of the movement of the first point toward the second point according to step (b) takes place in Cartesian coordinates x, y, z, and
the predetermined distance (d1) is reached and/or fallen below when further predetermined distances in the x, y, and z direction are reached and/or fallen below.

17. The method according to claim 15, wherein
after reaching and/or falling below the predetermined distance (d1), the change of the projected information on the at least one part of the surface of the operating element according to step (c) to the other or the further information element and/or the further illumination intensity of the at least one information element before reaching the predetermined distance (d1) or the other or the further information element takes place continuously with a decreasing distance of the first point from the second point.

18. The method according to claim 15, wherein
the at least one part of the surface of the operating element comprises a part of a surface of an actuator of the operating element and a further part of a surface area around the actuator of the operating element, and
the projection of information according to step (a) takes place on the part of the surface of the actuator of the operating element and/or the further part of the surface area around the actuator of the operating element.

19. The method according to claim 15, wherein
the projection of information on the at least one part of the surface of the operating element according to step (a) takes place from a projection position remote from the operating element.

20. The method according to claim 19, wherein the projection position is at a ceiling of an interior of the vehicle when the operating element is arranged in the vehicle.

21. The method according to claim 15, wherein
the detection of the movement of the first point toward the second point according to step (b) takes place from a detection position remote from the operating element.

22. The method according to claim 21, wherein the detection position is at a ceiling of an interior of the vehicle when the operating element is arranged in the vehicle.

23. The method according to claim 15, wherein devices used for projecting information according to step (a) and detecting the movement of the first point toward the second point according to step (b) are used not only for the operating element, but also for multiple physical operating elements or at least the one physical operating element and at least one geometrical two-dimensional user interface.

24. The method according to claim 15, further comprising the steps of:
d) maintaining the change of the projected information on the at least one part of the surface of the operating element according to step (c) on the other or the further information element and/or the further illumination intensity of the at least one information element before reaching the predetermined distance (d1) or the other or the further information element, as long as the operating element is operated, and/or
e) detecting a movement of a third point, facing toward the operating element, of the finger, the hand, or the elbow of the user of the operating element away from a fourth point on the surface of the operating element from a distance less than or equal to a further predetermined distance (d2), which is greater than or equal to the predetermined distance (d1), beyond the further predetermined distance (d2), and
f) changing the projected information on the at least one part of the surface of the operating element upon exceeding the further predetermined distance between the third point and the fourth point back to the at least one information element having the predetermined illumination intensity.

25. The method according to claim 24, wherein
the change of the projected information on the at least one part of the surface of the operating element upon exceeding the further predetermined distance (d2) between the third point and the fourth point according to step (f) first takes place when, after the detection of the movement of the third point away from the fourth point, a time interval of between 3000 ms and 5000 ms has expired, or a hysteresis loop between the predetermined distance (d1) upon the movement toward according to step (b) and the further predetermined distance (d2) upon exceeding according to step (f) has passed.

26. The method according to claim 15, wherein
the operating element comprises an operating element sensor for detecting an operation of the operating element.

27. The method according to claim 26, wherein the sensor is an electrical or inductive switch/button, a capacitive sensor, a pressure sensor, or a rotary actuator increment generator, which is used to detect an operation of the operating element.

28. The method according to claim 25, wherein steps (a) to (c) and steps (e) and (f) are repeated continuously until the operating element is switched off.

29. A system for projecting information, about a geometrical three-dimensional user interface, on the user interface, which user interface is arrangeable in a vehicle, comprising:
a projector, which is configured to project information about a function of the user interface which is in a form of a physical operating element, its status, its set value, or other optically displayable information related to the operating element, on at least one part of a surface of the operating element using at least one information element having a predetermined illumination intensity of the at least one information element;
a detection device, in the form of an infrared camera, a depth camera, a lidar sensor, or an ultrasonic sensor, which is configured to detect a movement of a first point (P1), facing toward the operating element, of a finger, a hand, or an elbow of a user of the operating element toward a second point (P2) on the surface of the operating element to a predetermined distance; and
c) a control device, which is configured to change the projected information on the at least one part of the surface of the operating element upon reaching and/or falling below the predetermined distance (d1) between the first point (P1) and the second point (P2) such that at least one information element other than the at least one information element is displayed before reaching the predetermined distance or a further information element in addition to the at least one information element is displayed before reaching the predetermined distance (d1), and/or a further illumination intensity of the at least one information element before reaching the predetermined distance (d1) or a/the other or further information element, which is displayed upon reaching and/or falling below the predetermined distance (d1), is higher than the illumination intensity of the at least one displayed information element before reaching the predetermined distance (d1).

30. A computer product comprising a non-transitory computer-readable medium having stored thereon program code which, when executed by a computer, carries out the acts of:
a) projecting information about a function of the user interface which is in a form of a physical operating element, its status, its set value, or other optically displayable information related to the operating element on at least one part of a surface of the operating element using at least one information element having a predetermined illumination intensity of the at least one information element;
b) detecting a movement of a first point, facing toward the operating element, of a finger, a hand, or an elbow of a user of the operating element toward a second point on the surface of the operating element to a predetermined distance (d1), and
c) changing the projected information on the at least one part of the surface of the operating element upon reaching and/or falling below the predetermined distance between the first point and the second point such that at least one information element other than the at least one information element is displayed before reaching the predetermined distance or a further information element in addition to the at least one information element is displayed before reaching the predetermined distance, and/or a further illumination intensity of the at least one information element before reaching the predetermined distance or a/the other or further information element, which is displayed upon reaching and/or falling below the predetermined distance, is higher than the illumination intensity of the at least one displayed information element before reaching the predetermined distance.
